(19) United States
(12) Patent Application Publication
(10) Pub. No.: US 2025/0111279 A1
(43) Pub. Date: Apr. 3, 2025

(54) LEARNING APPARATUS, GENERATION METHOD, MOVING OBJECT SYSTEM, AND STORAGE MEDIUM

(71) Applicant: HONDA MOTOR CO., LTD., Tokyo (JP)

(72) Inventors: Jaechul KIM, Wako-shi (JP); Longjiao ZHAO, Wako-shi (JP)

(21) Appl. No.: 18/891,920

(22) Filed: Sep. 20, 2024

(30) Foreign Application Priority Data
Sep. 28, 2023 (JP) 2023-168836

(51) Int. Cl. G06N 20/00

(52) U.S. Cl. CPC G06N 20/00

(57) ABSTRACT

A learning apparatus which generates a predetermined machine learning model capable of classifying an object included in data to be processed as any of a plurality of classes is disclosed. The apparatus generates the trained predetermined machine learning model, using data to be processed to which a label representing a class of the object is not assigned. The apparatus classifies the data using a trained first machine learning model capable of performing classification regarding a first class among the plurality of classes and classifies the data using a trained second machine learning model capable of performing classification regarding a second class among the plurality of classes, and trains the predetermined machine learning model based on classification results of the predetermined machine learning model, the first machine learning model, and the second machine learning model for the data.

### CROSS-REFERENCE TO RELATED APPLICATION(S)

This application claims priority to and the benefit of Japanese Patent Application No. 2023-168836, filed Sep. 28, 2023, the entire disclosure of which is incorporated herein by reference.

### BACKGROUND OF THE INVENTION

### Field of the Invention

The present invention relates to a learning apparatus, a generation method, a moving object system, and a storage medium.

### Description of the Related Art

In recent years, semi-supervised learning has been known as a method for appropriately training a model even when there are few pieces of data for which ground truth labels are set (Japanese Patent Laid-Open No. 2022-43923).

In the technique disclosed in Japanese Patent Laid-Open No. 2022-43923, a trained model A is generated by supervised learning based on data with a ground truth label, a ground truth label for data with no ground truth label is inferred using the model A, and the inferred ground truth label is set to data whose reliability at the time of inference is equal to or greater than a threshold. Thereafter, a trained model B is generated by performing supervised learning on the basis of the data with ground truth label and data in which the inferred ground truth label is set among the data with no ground truth label (that is, by performing semi-supervised learning).

Meanwhile, training data to which a ground truth label (for example, a target in an image) is assigned for data (for example, image data) is being provided from various entities such as companies and organizations. However, the classes set as the ground truth labels differ depending on the training data. For example, training data for training a classifier may include a data set in which the assigned classes are dogs and cats and a data set in which the assigned classes are dogs, elephants, and monkeys. In a case of generating a machine learning model that classifies a subject in an image (that classifies the subject as, for example, a dog, a bird, or a rabbit), a data set to which a necessary class is not assigned (to which, for example, only dogs and cats or only birds and cats are assigned) cannot be used as training data. In addition, Japanese Patent Laid-Open No. 2022-43923 does not consider a case of handling a model that classifies a target (object) as any of a plurality of classes.

### SUMMARY OF THE INVENTION

The present invention has been made in view of the above problems, and an object thereof is to provide a technique for efficiently training a machine learning model that classifies an object as any of a plurality of classes.

In order to solve the aforementioned issues, one aspect of the present disclosure provides a learning apparatus configured to generate a predetermined machine learning model capable of classifying an object included in data to be processed as any of a plurality of classes, the learning apparatus comprising a model generation unit configured to generate the predetermined machine learning model that has been trained, using data to be processed to which a label representing a class of the object is not assigned, wherein the model generation unit: classifies the data to be processed using a trained first machine learning model capable of performing classification regarding a first class among the plurality of classes; classifies the data to be processed using a trained second machine learning model capable of performing classification regarding a second class among the plurality of classes; and trains the predetermined machine learning model based on classification results of the predetermined machine learning model, the first machine learning model, and the second machine learning model for the data to be processed.

Another aspect of the present disclosure provides a generation method for generating a predetermined machine learning model capable of classifying an object included in data to be processed as any of a plurality of classes, the method comprising generating the predetermined machine learning model that has been trained, using data to be processed to which a label representing a class of the object is not assigned, wherein the generating the predetermined machine learning model includes: classifying the data to be processed using a trained first machine learning model capable of performing classification regarding a first class among the plurality of classes; classifying the data to be processed using a trained second machine learning model capable of performing classification regarding a second class among the plurality of classes; and training the predetermined machine learning model based on classification results of the predetermined machine learning model, the first machine learning model, and the second machine learning model for the data to be processed.

Still another aspect of the present disclosure provides a moving object system comprising a server, and a moving object, wherein the server generates a predetermined machine learning model capable of classifying an object included in data to be processed as any of a plurality of classes, and includes a model generation unit configured to generate the predetermined machine learning model that has been trained, using data to be processed to which a label representing a class of the object is not assigned, the moving object includes a classification unit configured to classify an object included in data to be processed acquired by the moving object as any of a plurality of classes by executing the predetermined machine learning model that has been generated, and the model generation unit: classifies the data to be processed using a trained first machine learning model capable of performing classification regarding a first class among the plurality of classes; classifies the data to be processed using a trained second machine learning model capable of performing classification regarding a second class among the plurality of classes; and trains the predetermined machine learning model based on classification results of the predetermined machine learning model, the first machine learning model, and the second machine learning model for the data to be processed.

Yet another aspect of the present disclosure provides a non-transitory computer-readable storage medium storing a program for causing a computer to function as each of unit of a learning apparatus, wherein the learning apparatus configured to generate a predetermined machine learning model capable of classifying an object included in data to be processed as any of a plurality of classes includes a model generation unit configured to generate the predetermined machine learning model that has been trained, using data to be processed to which a label representing a class of the object is not assigned, and the model generation unit: classifies the data to be processed using a trained first machine learning model capable of performing classification regarding a first class among the plurality of classes; classifies the data to be processed using a trained second machine learning model capable of performing classification regarding a second class among the plurality of classes; and trains the predetermined machine learning model based on classification results of the predetermined machine learning model, the first machine learning model, and the second machine learning model for the data to be processed.

According to the present invention, it is possible to efficiently train a machine learning model that classifies a target as any of a plurality of classes.

### BRIEF DESCRIPTION OF THE DRAWINGS

FIG. 1 is a block diagram illustrating a functional configuration example of a server as an example of a learning apparatus according to an embodiment;

FIG. 2 is a diagram for describing a method for training a target model according to the embodiment;

FIG. 3 is a diagram for describing an example of ground truth data according to the embodiment;

FIGS. 4A and 4B are diagrams for describing an example of an output of a machine learning model according to the embodiment;

FIG. 5 is a flowchart illustrating a series of processes for training the target model according to the embodiment;

FIG. 6 is a flowchart illustrating a series of processes for performing inference with the target model according to the embodiment;

FIG. 7 is a block diagram illustrating a functional configuration example of a moving object according to the embodiment; and

FIG. 8 is a diagram illustrating a main configuration for traveling control of the moving object according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Configuration of Server

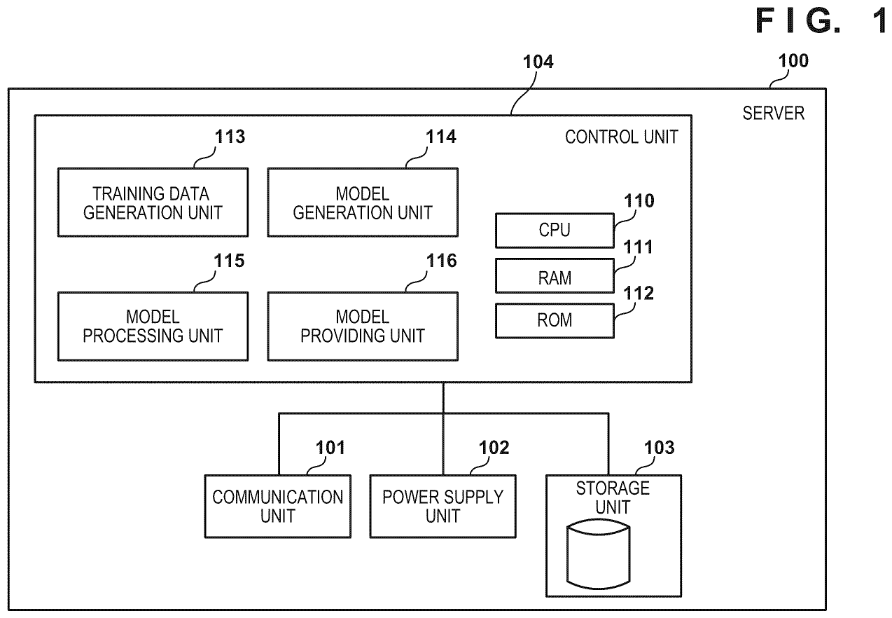

Next, a functional configuration example of a server will be described with reference to FIG. 1. Note that some of functional blocks to be described with reference to the attached drawings may be integrated together, or may be divided. In addition, a function to be described may be implemented by another block. Further, a functional block to be described as hardware may be implemented by software, and vice versa.

A control unit 104 includes, for example, a central processing unit (CPU) 110, a random access memory (RAM) 111, and a read-only memory (ROM) 112, and controls operation of each unit of a server 100. The CPU 110 includes one or more processors. The control unit 104 causes each unit included in the control unit 104 to fulfill its function by causing the CPU 110 to deploy, in the RAM 111, a computer program stored in the ROM 112 or a storage unit 103 and to execute the computer program. In addition to the CPU 110, the control unit 104 may further include a graphics processing unit (GPU) or dedicated hardware suitable for execution of machine learning processing.

A training data generation unit 113 acquires data necessary for training a model from various data sets of training data and generates a target data set as will be described in detail later. Each of the various data sets is a data set of training data for generating an existing machine learning model by supervised learning. These data sets include data to be processed (for example, image data) and labels (ground truth labels) representing classes, positions, and the like of objects included in the data to be processed. Each of the data sets is generated for a unique purpose as it is generated. Therefore, types of objects included in the data sets are different. A data set of certain training data is a data set for classifying objects into a person and a vehicle, and labels representing classes include persons and vehicles. However, this data set of training data does not include a label representing bicycles. A data set of another training data is a data set for classifying objects into a person and a sign, and labels representing classes include persons and signs. However, this data set of training data does not include a label representing vehicles.

It is assumed that a machine learning model (also referred to as a target model) to be trained described below is a machine learning model that classifies objects in image data into, for example, a vehicle and a sign. In this case, the training data generation unit 113 analyzes the above-mentioned various data sets of the training data, and selects training data to which at least one of a label representing vehicles and a label representing signs is assigned from these data sets. Then, the training data generation unit 113 generates a new data set (that is, a target data set) including at least training data to which a label representing vehicles is assigned and data to which a label representing signs is assigned.

A model generation unit 114 performs processing in a training phase of the machine learning model according to the present embodiment. The machine learning model performs, for example, operation of a deep learning algorithm using a deep neural network (DNN) to classify the objects (also referred to as targets) included in image data. The objects may include a pedestrian, a vehicle, a bicycle, a signboard, a sign, a road, an animal, a building, a traffic sign, a white line or yellow line on the road, and the like included in an image.

The machine learning model is brought into a trained state by the model generation unit 114 performing processing in the training phase to be described later. Then, by inputting unknown data (for example, new image data) to the trained machine learning model, it is possible to perform object classification (processing in an inference phase) for the unknown data.

A model processing unit 115 executes processing in the inference phase of the machine learning model. The processing in the inference phase is performed in a case where inference processing using a trained machine learning model is performed in the server 100. The server 100 executes the inference processing using the trained model on the server 100 side, and transmits an inference result to an external device such as a moving object (for example, a vehicle) or an information processing apparatus. Alternatively, the processing in the inference phase based on the machine learning model may be performed in the moving object. In a case where the processing in the inference phase based on the machine learning model is performed in the moving object, a model providing unit 116 provides information regarding the trained model to the external device such as a moving object.

In a case where the inference processing using the trained machine learning model is performed in the moving object, the model providing unit 116 transmits information regarding the trained model trained by the server 100 to the moving object. For example, when receiving the information regarding the trained model from the server 100, the moving object updates a machine learning model in the vehicle with the latest machine learning model, and performs object classification processing (inference processing) using the latest machine learning model. The information regarding the trained machine learning model includes information regarding the version of the trained model and, in a case where the machine learning model is a neural network, information such as a weighting factor and a hyperparameter of the trained neural network.

A communication unit 101 is, for example, a communication device including a communication circuit and the like, and communicates with the external device such as a moving object through a network such as the Internet. The communication unit 101 may receive data to be processed (for example, a real image) transmitted from the external device such as a moving object. The communication unit 101 acquires a part of the above-described training data from an external server or the like via a network. The communication unit 101 may transmit information regarding the trained machine learning model to the moving object at a predetermined timing or cycle. A power supply unit 102 supplies electric power to each unit in the server 100. The storage unit 103 is a nonvolatile memory such as a hard disk or a semiconductor memory. The storage unit 103 stores training data to be described below, a program to be executed by the CPU 110, other data, and the like.

### Method for Training Target Model

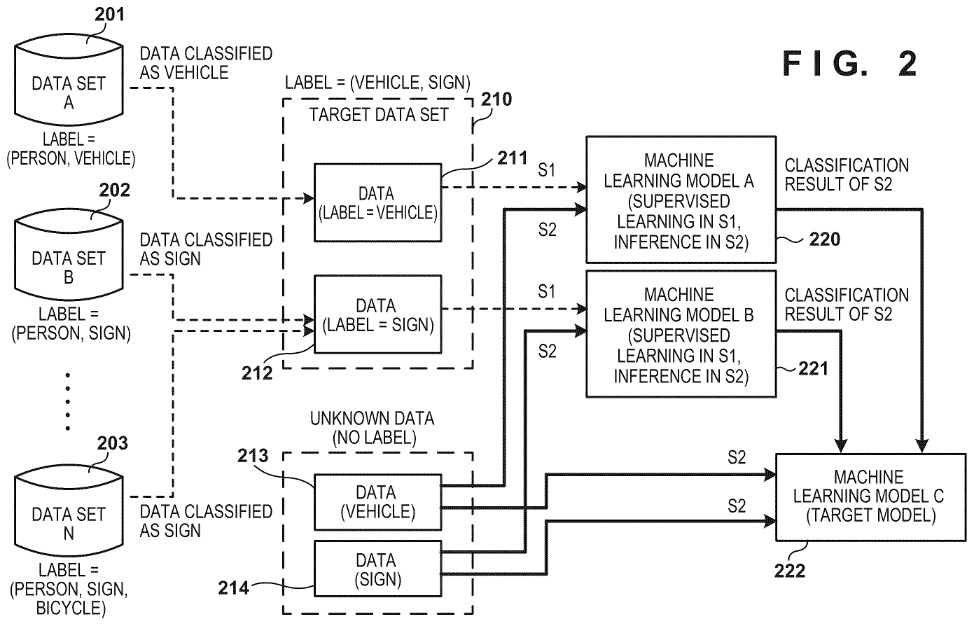

Next, a method for training the target model according to the present embodiment will be described with reference to FIG. 2. The example illustrated in FIG. 2 indicates, as an example, a case where a machine learning model C to be the target model is trained so as to classify an object in data to be processed as a vehicle or a sign.

A data set A201, a data set B202, and a data set N203 illustrated in FIG. 2 are data sets of existing training data. That is, each of the data sets is a data set of training data for generating an existing machine learning model by supervised learning. The data set A201 is a data set of training data for classifying objects into a person and a vehicle, and labels representing classes include persons and vehicles. The target model classifies an object as a vehicle or a sign, and the classification mode is different from the classification mode of the data set A. Therefore, the target model cannot be trained by directly using the data set A. In the present embodiment, in order to effectively utilize the existing training data sets having different classification modes, data and label information necessary for training the target model are selectively acquired from these existing data sets, and a new data set (target data set 210) of training data is generated.

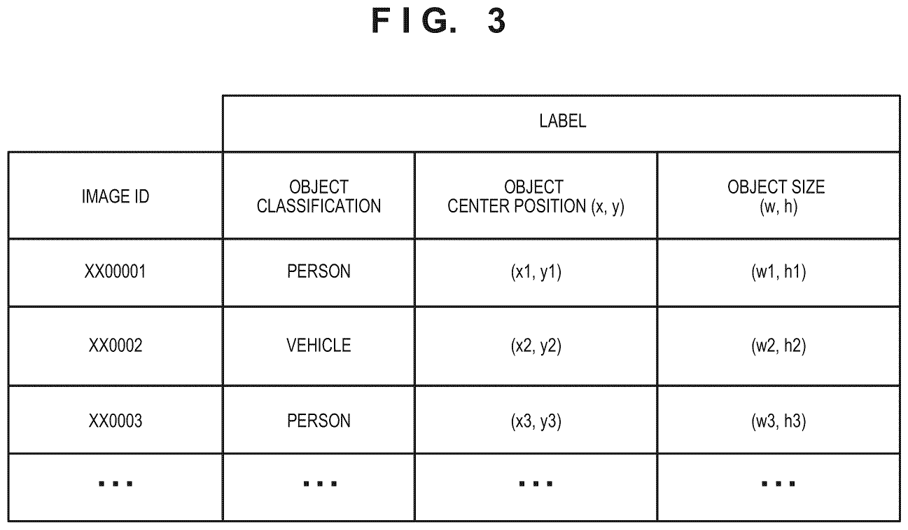

FIG. 3 illustrates an example of a label of the data set A201. The label includes, with respect to an image ID included in the data set A201, information indicating the class of an object in the image and information indicating the position and size of the object (that is, a boundary box of the object). For example, the training data generation unit 113 acquires data classified as a vehicle and label information thereof from the data set A201, and generates the target data set 210 including the data 211. The data 211 is used to train the machine learning model A220 that classifies an object as a vehicle.

Similarly, the training data generation unit 113 acquires data classified as a sign and label information thereof from the data set B202 and the data set N203, and generates data 212. The data 212 is used to train the machine learning model B221 that classifies an object as a sign. Note that, as an example, the data set B202 is a data set of training data for classifying objects into a person and a sign, and the data set N203 is a data set of training data for classifying objects into a person, a sign, and a bicycle.

At this time, as an example, the training data generation unit 113 can set the labels of the data 211 and the data 212 included in the target data set 210 to include information indicating the classes of the objects and information indicating the positions and sizes of the objects (that is, the boundary boxes of the objects) as illustrated in FIG. 3.

As described above, the training data generation unit 113 selects training data to which at least one of the label representing vehicles or the label representing signs is assigned from labeled training data pieces. Thus, the training data generation unit 113 generates a new data set including at least training data to which the label representing vehicles is assigned and data to which the label representing signs is assigned.

The training data generation unit 113 acquires training data for each of the classes in a cross-sectional manner from a plurality of existing training data pieces, and acquires the training data so that a predetermined sufficient amount of training data for each class is obtained. In this way, it is easy to address the shortage of samples for some classification labels and the bias in data. When having imbalance in the number of labels such as persons and vehicles, each of the existing data sets may have a possibility that the accuracy is not sufficiently improved for some classes due to a shortage of samples, the bias in data, or the like. However, such a problem can be solved in the present embodiment that acquires the training data for each class in a cross-sectional manner from a plurality of existing training data pieces and acquires a sufficient amount of training data.

Next, the model generation unit 114 trains an individual machine learning model that classifies an object as each of the classes using the generated target data set 210 as a phase prior to training the target model. For example, as a first phase (S1), the model generation unit 114 trains the machine learning model A220 that performs classification for vehicles using training data (data 211) to which a label representing vehicles is assigned. In addition, still as the first phase (S1), the model generation unit 114 trains the machine learning model B221 that performs classification for signs using training data (data 212) to which a label representing signs is assigned.

The machine learning model A220 and the machine learning model B221 are trained in this manner, and thus, when receiving unknown data including an object that is a vehicle or a sign, these machine learning models can appropriately classify the object.

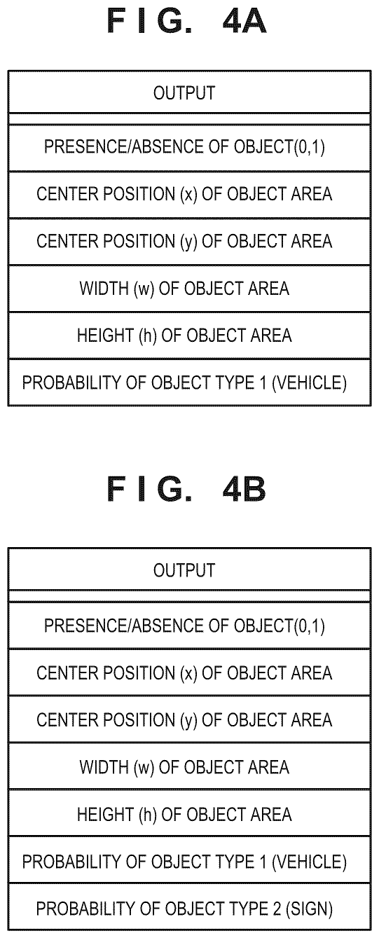

Next, as a second phase (S2), the model generation unit 114 trains the target model (that is, generates a trained machine learning model) using unknown data 213 and 214 to which no label is assigned. The model generation unit 114 inputs the unknown data to each of the trained machine learning model A220, the trained machine learning model B221, and a machine learning model C222. For example, the trained machine learning model A220 can output a classification result as illustrated in FIG. 4A. For example, the classification result includes the presence or absence of an object, the position and size of an object area, and the probability that the object is a vehicle. Similarly, the trained machine learning model B221 can output a classification result including the presence or absence of an object, the position and size of an object area, and the probability that the object is a sign. In addition, the machine learning model C222 can output a classification result as illustrated in FIG. 4B as an example. The classification result of the machine learning model C222 includes both the probability that the object is a vehicle and the probability that the object is a sign.

The model generation unit 114 trains the machine learning model C222 on the basis of the classification results for the unknown data by the machine learning model A220, the machine learning model B221, and the machine learning model C222. For example, the model generation unit 114 changes a weighting factor of the machine learning model C222 so that an error function defined by the classification results of the machine learning model C222 and the machine learning model A220 for the unknown data decreases (that is, a difference between the classification results of the models decreases). In addition, the model generation unit 114 changes a weighting factor of the machine learning model C222 so that an error function defined by the classification results of the machine learning model C222 and the machine learning model B221 for the unknown data decreases (that is, a difference between the classification results of the models decreases). The model generation unit 114 optimizes the machine learning model C222 by changing the weighting factor using a plurality of unknown data pieces or by repeatedly using a plurality of unknown data pieces. Note that, in the above description, the case where only unknown data is used to train the machine learning model C222 has been described as an example. However, the target model may be further trained using the data 211 and the data 212 included in the target data set. That is, the model generation unit 114 may further train the machine learning model C222 by supervised learning. That is, the weighting factor of the machine learning model C222 may be changed so that the difference between the classification result of the machine learning model C222 and the label decreases.

In this way, the present embodiment can effectively utilize the existing training data, even when the classification mode of the existing training data is different from the classification mode of the target model. In other words, it is possible to efficiently train a machine learning model that classifies a target as any of a plurality of classes.

In addition, according to the above-described embodiment, the training data corresponding to an individual class can be collected as necessary without depending on another class. When having imbalance in the number of labels such as persons and vehicles, each of the existing data sets may have a possibility that the accuracy is not sufficiently improved for some classes due to a shortage of samples, the bias in data, or the like. In the present embodiment, the training data for an individual class can be acquired from a plurality of data sets in a cross-sectional manner, whereby it is easy to address the shortage of samples for some classification labels and the bias in data.

Furthermore, according to the above-described embodiment, a plurality of individual machine learning models corresponding to individual classes is used, whereby it is possible to train a new machine learning model having a different classification mode by utilizing individual ground truth data among existing training data pieces having different classification modes.

### Series of Processes of Processing Performed by Server in Training Phase

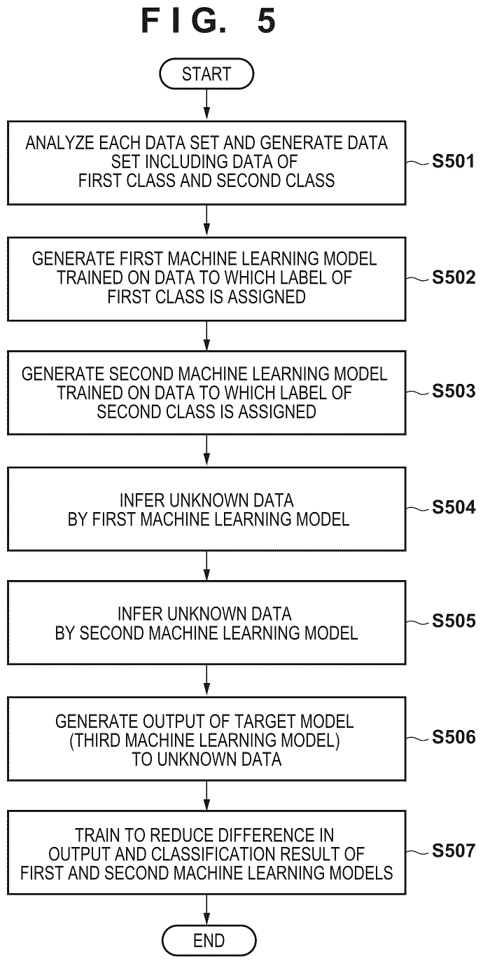

Next, a series of processes of processing in the training phase of the machine learning model according to the present embodiment will be described with reference to FIG. 5. The control unit 104 of the server 100 causes each unit included in the control unit 104 to fulfill its function by deploying, in the RAM 111, a computer program stored in the ROM 112 or the storage unit 103 and by executing the computer program. Thus, the series of processes described here are implemented. In addition, the following processing will be described by taking, as an example, a case where the target model is trained to classify objects into a first class and a second class (for example, a vehicle and a sign). The designation of these classes may be determined in advance or may be input by an administrator of the server (generator of the machine learning model).

In S501, the training data generation unit 113 analyzes each data set and generates a data set including data of the first class and data of the second class as described above. Then, in S502, the model generation unit 114 generates a trained first machine learning model (for example, the machine learning model A220) using the data to which a label representing the first class (for example, a vehicle) is assigned as described above. In addition, in S503, the model generation unit 114 generates a trained second machine learning model (for example, the machine learning model B221) using the data to which a label representing the second class (for example, a sign) is assigned as described above.

The model generation unit 114 infers unknown data using the first machine learning model as described above in S504, and infers unknown data using the second machine learning model as described above in S505. The model generation unit 114 acquires classification results as described above from the machine learning models, respectively. In addition, in S506, the model generation unit 114 generates an output of a target model (for example, the machine learning model C222) to unknown data as described above. Then, in S507, the target model is trained so as to reduce a difference between the classification result of the target model and the classification result of the first machine learning model and a difference between the classification result of the target model and the classification result of the second machine learning model. When the target model is sufficiently optimized, the control unit 104 ends the series of processes related to the present processing.

### Series of Processes Performed by Model Processing Unit in Inference Phase

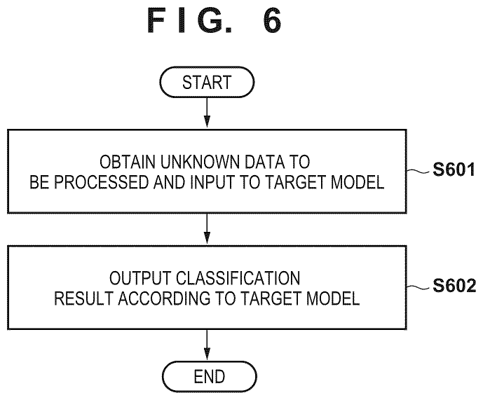

Next, a series of processes performed by the model processing unit 115 of the server 100 in the inference phase according to the present embodiment will be described with reference to FIG. 6. The control unit 104 causes each unit included in the control unit 104 to fulfill its function by deploying, in the RAM 111, a computer program stored in the ROM 112 or the storage unit 103 and by executing the computer program. Thus, the series of processes described here are implemented.
In S601, the model processing unit 115 acquires unknown data to be processed from an external device such as a moving object via a network, for example, and inputs the acquired data to be processed to the target model (for example, the machine learning model C222).
In S602, the model processing unit 115 executes the processes in the inference phase based on the target model, and outputs, for example, the classification result illustrated in FIG. 4B. When the inference processing ends, the control unit 104 ends a series of processes related to the present processing.

Note that, in the above example, the case where the server 100 executes the inference processing using the trained machine learning model has been described as an example. However, the inference processing of the generated machine learning model can be executed in various devices. Hereinafter, a case where the trained machine learning model generated by the server 100 is distributed to another device via a network, and the classification processing is executed using the machine learning model distributed by the device will be described. As an example, a case where another device is, for example, a moving object will be described as an example. The moving object may include a vehicle or a two-wheeled vehicle that can travel by an internal combustion engine or electric power, a robot that can travel autonomously, and the like.

### Configuration of Moving Object

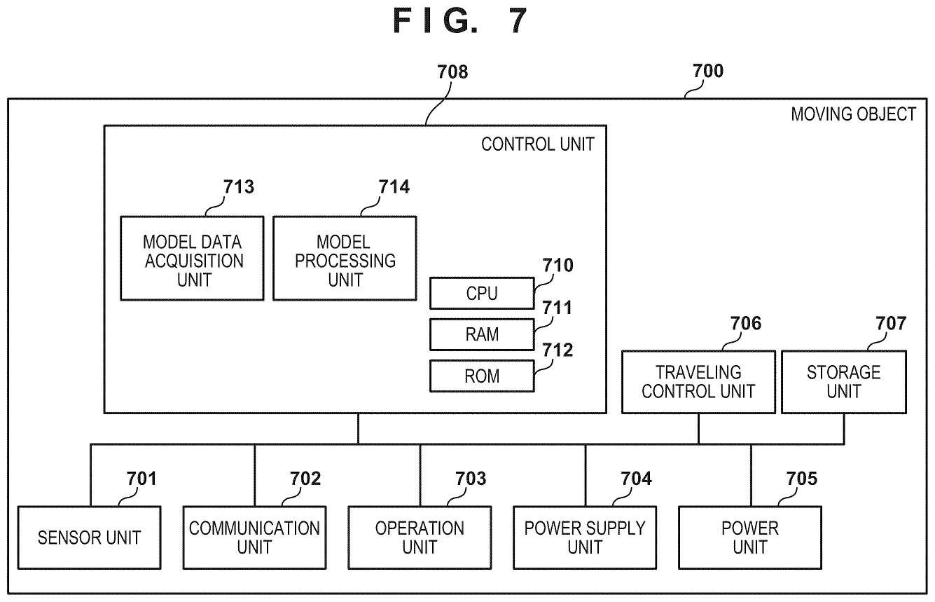

A functional configuration example of a moving object 700 according to the present embodiment will be described with reference to FIG. 7. Note that some of functional blocks to be described with reference to the attached drawings may be integrated together, or may be divided. In addition, a function to be described may be implemented by another block. Further, a functional block to be described as hardware may be implemented by software, and vice versa.

A sensor unit 701 includes a camera (imaging unit) that outputs a captured image of a forward view (or also a rear view and a view of surroundings) from the moving object. The sensor unit 701 may further include a light detection and ranging (Lidar) that outputs a range image obtained by measurement of a distance to an object in front of the moving object (or also distances to objects in the rear of and around the moving object). The captured image is used, for example, for inference processing of object classification in the model processing unit 714. In addition, the sensor unit 701 may include various sensors that output acceleration, position information, a steering angle, and the like of the moving object 700.

A communication unit 702 is a communication device including, for example, a communication circuit, and communicates with the server 100, a transportation system located around the moving object, and the like through, for example, Long Term Evolution (LTE), LTE-Advanced, or mobile communication standardized as the so-called fifth generation mobile communication system (5G). In addition, the communication unit 702 receives a part or all of map data, traffic information, and the like from another server or the transportation system located around the moving object.

An operation unit 703 includes an operation member such as a button or a touch panel installed in the moving object 700 and members that receive an input for driving the moving object 700, such as a steering wheel and a brake pedal. A power supply unit 704 includes a battery including, for example, a lithium-ion battery, and supplies electric power to each unit in the moving object 700. A power unit 705 includes, for example, an engine or a motor that generates power for moving the moving object.

A traveling control unit 706 controls the traveling of the moving object 700 in such a way as to, for example, recognize a sign or cause the moving object 700 to follow a preceding vehicle while traveling on the basis of a result of the inference processing (for example, object classification result) output from the model processing unit 714. Note that in the present embodiment, such traveling control can be performed using a known method. Although the present embodiment has described the case where the traveling control unit 706 and the control unit 708 are separate components, the traveling control unit 706 may be included in the control unit 708.

A storage unit 707 includes a nonvolatile mass storage device such as a semiconductor memory. The storage unit 707 temporarily stores an actual image output from the sensor unit 701 and sensor data from various sensors output from the sensor unit 701. In addition, a model data acquisition unit 713 to be described below stores information regarding the trained machine learning model received from, for example, the server 100 external to the moving object 700 via the communication unit 702. The information regarding the trained machine learning model includes information regarding the version of the trained model and, in a case where the machine learning model is a neural network, information such as a weighting factor and a hyperparameter of the trained neural network.

The control unit 708 includes, for example, a CPU 710, a RAM 711, and a ROM 712, and controls operation of each unit of the moving object 700. Furthermore, the control unit 708 acquires image data from the sensor unit 701 and executes the inference processing including the object classification processing, and the like. The control unit 708 causes the units, such as the model processing unit 714, included in the control unit 708 to fulfill their respective functions, by causing the CPU 710 to deploy, in the RAM 711, a computer program stored in the ROM 712 and to execute the computer program.

The CPU 710 includes one or more processors. The RAM 711 includes a volatile storage medium such as a dynamic RAM (DRAM), and functions as a working memory of the CPU 710. The ROM 712 includes a nonvolatile storage medium, and stores, for example, a computer program to be executed by the CPU 710 and a setting value to be used when the control unit 708 is operated. Note that the following embodiment will describe, as an example, a case where the CPU 710 implements the processing performed by the model processing unit 714, but the processing performed by the model processing unit 714 may be implemented by one or more other processors (for example, graphics processing units (GPUs)) (not illustrated).

The model data acquisition unit 713 acquires information regarding the trained machine learning model from the server 100 as described above. The model processing unit 714 executes processing in the inference phase of the machine learning model acquired by the model data acquisition unit 713. The processing in the inference phase to be performed by the model processing unit 714 can be performed as with the above-mentioned processing in the inference phase with reference to FIG. 6.

### Main Configuration for Traveling Control of Moving Object>

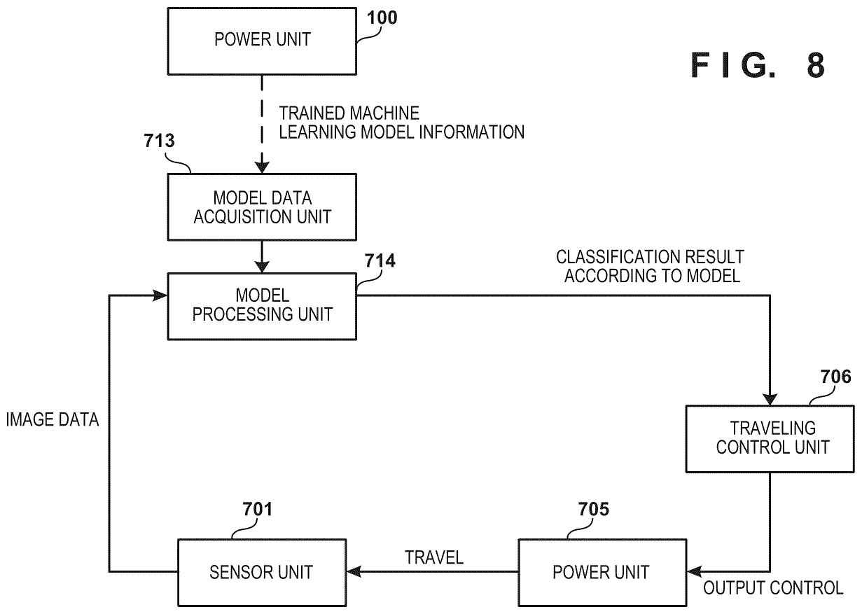

Next, a main configuration for traveling control of the moving object 700 will be described with reference to FIG. 8. First, the model data acquisition unit 713 acquires information regarding the machine learning model transmitted from the server 100. The model data acquisition unit 713 updates the machine learning model to be executed by the model processing unit 714 on the basis of the acquired information.

The sensor unit 701 captures, for example, images of a forward view from the moving object 700, and outputs image data of the captured images a predetermined number of times per second. The image data output from the sensor unit 701 are input to the model processing unit 714 of the control unit 708. The image data input to the model processing unit 714 are used for, for example, object classification processing (processing in the inference phase) for controlling the traveling of the moving object at the present moment.

The model processing unit 714 receives input of the image data output from the sensor unit 701, performs object classification processing, and outputs a classification result to the traveling control unit 706. The classification result may be similar to the output data shown in FIG. 4B.

The traveling control unit 706 performs moving object control for the moving object 700 by outputting a control signal to, for example, the power unit 705 on the basis of the classification result and various types of sensor information such as the acceleration and steering angle of the moving object obtained from the sensor unit 701. The moving object control performed by the traveling control unit 706 can be performed using a known method as described, and thus, details are omitted in the present embodiment. The power unit 705 controls generation of power according to the control signal from the traveling control unit 706.

As described above, the present embodiment can effectively utilize the existing training data, even when the classification mode of the data set of the existing training data is different from the classification mode of the target model. In other words, it is possible to efficiently train a machine learning model that classifies a target as any of a plurality of classes.

### Summary of Embodiments

The above-described embodiment includes modes of a learning apparatus, a generation method, and a moving object system.

### Item 1

A learning apparatus configured to generate a predetermined machine learning model capable of classifying an object included in data to be processed as any of a plurality of classes, the learning apparatus comprising
a model generation unit configured to generate the predetermined machine learning model that has been trained, using data to be processed to which a label representing a class of the object is not assigned, wherein
the model generation unit:
   classifies the data to be processed using a trained first machine learning model capable of performing classification regarding a first class among the plurality of classes;
   classifies the data to be processed using a trained second machine learning model capable of performing classification regarding a second class among the plurality of classes; and
   trains the predetermined machine learning model based on classification results of the predetermined machine learning model, the first machine learning model, and the second machine learning model for the data to be processed.

According to this aspect, it is possible to efficiently train a machine learning model that classifies a target as any of a plurality of classes. In addition, a predetermined machine learning model capable of classifying an object as any of a plurality of classes can be trained using data to which a label representing the class of the object is not assigned. This greatly increases data available for training.

### Item 2

The learning apparatus according to item 1, wherein,
before training the predetermined machine learning model, the model generation unit:
   trains the first machine learning model that performs classification regarding the first class using training data to which a label representing the first class is assigned; and
   trains the second machine learning model that performs classification regarding the second class using training data to which a label representing the second class is assigned.

According to this aspect, a plurality of individual machine learning models corresponding to individual classes is used, whereby it is possible to train a new machine learning model having a different classification mode by utilizing individual ground truth data among existing training data pieces having different classification modes.

### Item 3

The learning apparatus according to item 2, further comprising a data generation unit configured to generate a new data set including at least the training data to which the label representing the first class is assigned and the training data to which the label representing the second class is assigned by selecting training data to which at least one of the label representing the first class or the label representing the second class is assigned from among labeled training data.

According to this aspect, it is possible to acquire data that can be utilized among existing training data having different classification modes, and generate a data set necessary for training of individual classifications.

### Item 4

The learning apparatus according to any one of items 1-4, wherein the model generation unit trains the predetermined machine learning model so as to reduce a difference between the classification results of the predetermined machine learning model and the first machine learning model for the data to be processed and a difference between the classification results of the predetermined machine learning model and the second machine learning model for the data to be processed.

According to this aspect, it is possible to train the classification for each class using an output by the first machine learning model and an output by the second machine learning model as training data.

### Item 5

A generation method for generating a predetermined machine learning model capable of classifying an object included in data to be processed as any of a plurality of classes, the method comprising
generating the predetermined machine learning model that has been trained, using data to be processed to which a label representing a class of the object is not assigned, wherein
the generating the predetermined machine learning model includes:
   classifying the data to be processed using a trained first machine learning model capable of performing classification regarding a first class among the plurality of classes;
   classifying the data to be processed using a trained second machine learning model capable of performing classification regarding a second class among the plurality of classes; and
   training the predetermined machine learning model based on classification results of the predetermined machine learning model, the first machine learning model, and the second machine learning model for the data to be processed.

According to this aspect, it is possible to efficiently generate a machine learning model that classifies a target as any of a plurality of classes. Furthermore, a predetermined machine learning model capable of classifying an object as any of a plurality of classes can be generated using data to which a label representing the class of the object is not assigned.

### Item 6

A moving object system comprising a server, and a moving object, wherein
the server generates a predetermined machine learning model capable of classifying an object included in data to be processed as any of a plurality of classes, and includes a model generation unit configured to generate the predetermined machine learning model that has been trained, using data to be processed to which a label representing a class of the object is not assigned,
the moving object includes a classification unit configured to classify an object included in data to be processed acquired by the moving object as any of a plurality of classes by executing the predetermined machine learning model that has been generated, and
the model generation unit:
   classifies the data to be processed using a trained first machine learning model capable of performing classification regarding a first class among the plurality of classes;
   classifies the data to be processed using a trained second machine learning model capable of performing classification regarding a second class among the plurality of classes; and
   trains the predetermined machine learning model based on classification results of the predetermined machine learning model, the first machine learning model, and the second machine learning model for the data to be processed.

According to this aspect, it is possible to efficiently train a machine learning model that classifies a target as any of a plurality of classes. In addition, a predetermined machine learning model capable of classifying an object as any of a plurality of classes can be trained using data to which a label representing the class of the object is not assigned.

The invention is not limited to the foregoing embodiments, and various variations/changes are possible within the spirit of the invention.

What is claimed is:

1. A learning apparatus configured to generate a predetermined machine learning model capable of classifying an object included in data to be processed as any of a plurality of classes, the learning apparatus comprising
a model generation unit configured to generate the predetermined machine learning model that has been trained, using data to be processed to which a label representing a class of the object is not assigned, wherein
the model generation unit:
classifies the data to be processed using a trained first machine learning model capable of performing classification regarding a first class among the plurality of classes;
classifies the data to be processed using a trained second machine learning model capable of performing classification regarding a second class among the plurality of classes; and
trains the predetermined machine learning model based on classification results of the predetermined machine learning model, the first machine learning model, and the second machine learning model for the data to be processed.

2. The learning apparatus according to claim 1, wherein,
before training the predetermined machine learning model, the model generation unit:
trains the first machine learning model that performs classification regarding the first class using training data to which a label representing the first class is assigned; and
trains the second machine learning model that performs classification regarding the second class using training data to which a label representing the second class is assigned.

3. The learning apparatus according to claim 2, further comprising a data generation unit configured to generate a new data set including at least the training data to which the label representing the first class is assigned and the training data to which the label representing the second class is assigned by selecting training data to which at least one of the label representing the first class or the label representing the second class is assigned from among labeled training data.

4. The learning apparatus according to claim 1, wherein the model generation unit trains the predetermined machine learning model so as to reduce a difference between the classification results of the predetermined machine learning model and the first machine learning model for the data to be processed and a difference between the classification results of the predetermined machine learning model and the second machine learning model for the data to be processed.

5. A generation method for generating a predetermined machine learning model capable of classifying an object included in data to be processed as any of a plurality of classes, the method comprising
generating the predetermined machine learning model that has been trained, using data to be processed to which a label representing a class of the object is not assigned, wherein
the generating the predetermined machine learning model includes:
classifying the data to be processed using a trained first machine learning model capable of performing classification regarding a first class among the plurality of classes;
classifying the data to be processed using a trained second machine learning model capable of performing classification regarding a second class among the plurality of classes; and
training the predetermined machine learning model based on classification results of the predetermined machine learning model, the first machine learning model, and the second machine learning model for the data to be processed.

6. A moving object system comprising a server, and a moving object, wherein
the server generates a predetermined machine learning model capable of classifying an object included in data to be processed as any of a plurality of classes, and includes a model generation unit configured to generate the predetermined machine learning model that has been trained, using data to be processed to which a label representing a class of the object is not assigned,
the moving object includes a classification unit configured to classify an object included in data to be processed acquired by the moving object as any of a plurality of classes by executing the predetermined machine learning model that has been generated, and
the model generation unit:
classifies the data to be processed using a trained first machine learning model capable of performing classification regarding a first class among the plurality of classes;
classifies the data to be processed using a trained second machine learning model capable of performing classification regarding a second class among the plurality of classes; and
trains the predetermined machine learning model based on classification results of the predetermined machine learning model, the first machine learning model, and the second machine learning model for the data to be processed.

7. A non-transitory computer-readable storage medium storing a program for causing a computer to function as each of unit of a learning apparatus, wherein
the learning apparatus configured to generate a predetermined machine learning model capable of classifying an object included in data to be processed as any of a plurality of classes includes
a model generation unit configured to generate the predetermined machine learning model that has been trained, using data to be processed to which a label representing a class of the object is not assigned, and
the model generation unit:
classifies the data to be processed using a trained first machine learning model capable of performing classification regarding a first class among the plurality of classes;
classifies the data to be processed using a trained second machine learning model capable of performing classification regarding a second class among the plurality of classes; and
trains the predetermined machine learning model based on classification results of the predetermined machine learning model, the first machine learning model, and the second machine learning model for the data to be processed.
